(19) United States
(12) Patent Application Publication
(10) Pub. No.: US 2011/0109007 A1
(43) Pub. Date: May 12, 2011

(54) RECYCLED POST-INDUSTRIAL WASTE FOR PLASTIC INDUSTRIAL COMMERCIAL AND CONSUMER PRODUCTS

(76) Inventor: Kenneth Joseph Ardrey, Farmington, MO (US)

(21) Appl. No.: 12/615,916

(22) Filed: Nov. 10, 2009

(51) Int. Cl. B29B 9/16

(52) U.S. Cl. 264/143

(57) ABSTRACT

This invention presents a recycle system for making recycled plastic pellets. The system includes a shredder for shredding raw material, an extruder for extruding strands from the shredded raw material, a cooler for cooling the strands, and a cutter for cutting the strands into pellets. The cooler cools the strands such that the temperature of the strands is maintained above a predetermined temperature. The predetermined temperature can be a boiling point of water when the cooler cools the strands with mist.

### CROSS-REFERENCE TO RELATED APPLICATIONS

Not Applicable.

### STATEMENT REGARDING FEDERALLY SPONSORED RESEARCH OR DEVELOPMENT

Not Applicable.

### APPENDIX

Not Applicable.

### BACKGROUND OF THE INVENTION

1. Field of the Invention

The present invention relates generally to recycling of post-industrial waste and, more particularly to a system for recycling plastic waste to produce recycled plastic pellets.

2. Description of Related Art

There have been various systems for recycling post-industrial waste, such as diapers or feminine products. These types of scrap could be 85-99% polypropylene, which is used in most consumer and commercial industrial products. The waste may contains cellulose, SAP, adhesives, or polyethylene. The contaminants made the waste difficult to process by traditional methods involving extruder process.

A conventional method extracts as much of the contaminants before the conversion into pellets. This method utilizes a shredder with vacuum systems to pull the lighter contaminants away from the plastic material. Afterward, the method converts the material into pellets (such as California pellets) which can be put into bags for future storage.

A conventional method uses an underwater cutter at the end of the extruder line, which causes the material to carry excess moisture. This conventional type of underwater cutter is arranged in a water-filled area as the material comes out of the die head of the extruder. This water instantly cures the material and then there is a cutter that spins to cut the pellets. Once the pellets are cut they flow to a drying/shaker table and then into a small drying unit. An Erema extruder line, which is commercially available, soaks up water and takes several days to dry in a traditional material drier. Once dried the material could be molded without any special equipment, but the drying is too expensive.

Another conventional cutting for an extruder process is to employ hot plate cutters, which have two hot plates. As the material comes through the plates spin to cure and cut the pellets. The pellets cut by the hot plate cutters are not as clean cut as the pellets obtained by the conventional underwater cutter. In addition, the output of the hot plate cutters is less than 700 lbs per hour, which is a large capacity constraint. This is too slow, which would make the final pellets too expensive.

### SUMMARY OF THE INVENTION

Accordingly, the present invention has been made to solve the above-mentioned occurring in the prior art. One aspect of the present invention provides a recycle system for making recycled plastic pellets comprising. The recycle system includes a shredder for shredding raw material, an extruder for extruding strands from the shredded raw material, a cooler for cooling the strands, and a cutter for cutting the strands into pellets. The cooler cools the strands such that the temperature of the strands is maintained above a predetermined temperature.

In a preferred embodiment, the cooler is comprised of a cooling conveyor. Preferably, the cooler further cools the strands with mist sprayers. Preferably, the cooler maintains the temperature of the strands above a boiling point of water to keep the strands dry.

In a preferred embodiment, the extruder further has a densifier for receiving and densifying the shredded raw material. The extruder can further have an additive feeder for adding additive into the densifier. Preferably, the extruder further has an extrusion screw for receiving the densified raw material, a heater for adding heat to the extrusion screw to melt the densified raw material passing through the extrusion screw, and a head die for creating strands from the melted raw material. Optionally, the extruder can further have a color feeder for adding color to the raw material passing through the extrusion screw. Preferably, the extruder further has a vacuum area for removing impurities out the raw material passing through the extrusion screw.

Another aspect of the present invention provides a process for making recycled plastic pellets. The process includes steps of shredding raw material in a shredding station, extruding strands from the shredded raw material in an extruding station, cooling the strands such that the temperature of the strands are maintained above a predetermined temperature in a cooling station, and cutting the strands into pellets in a cutting station.

In a preferred embodiment, the cooling step includes spraying the strands with mist. The cooling step maintains the temperature of the strands above a boiling point of water to keep the strands dray.

In a preferred embodiment, the extruding step further includes densifying the shredded raw material in a densifier. The extruding step can further include adding additive to the shredded raw material. Preferably, the extruding step further includes passing the densified raw material through an extrusion screw, adding heat to the extruding screw to melt the densified raw material passing through the extrusion screw, and passing the melt raw material through a head die to form strands. Optionally, the extruding step can further include adding color to the raw material passing through the extrusion screw. Preferably, the extruding step further includes vacuuming the raw material passing through the extrusion screw to remove impurities therefrom.

In a preferred embodiment, the strands are moved from the extruding station to the cutting station, during which the strands are further cooled.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The above and other objects and features of the present invention will become apparent from the following description of preferred embodiments given in conjunction with the accompanying drawings, in which:

FIG. 1 shows a schematic view of a recycle system for making recycled plastic pellets according to an embodiment of the present invention.

FIG. 2 shows a further detailed schematic view of the shredder and the conveyor of the recycle system of FIG. 1.

FIG. 3 shows a further detailed schematic view of the extruder of the recycle system of FIG. 1.

FIG. 4 shows a further detailed schematic view of the cooler and cutter of the recycle system of FIG. 1.

FIG. 5 shows pellets produced with the recycle system of FIG. 1.

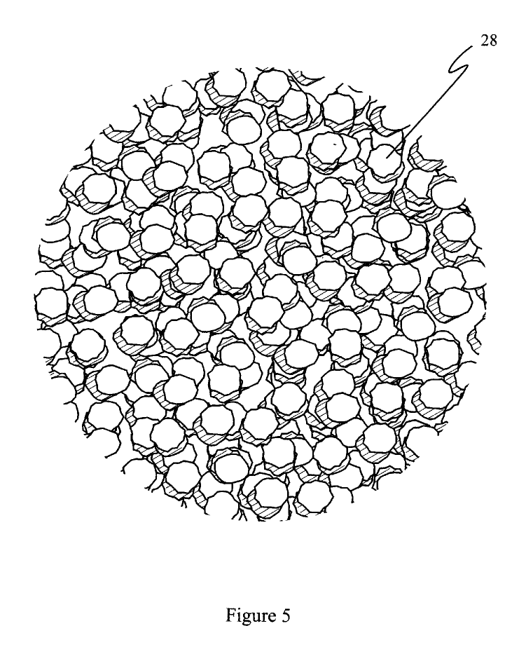

### DETAILED DESCRIPTION OF THE INVENTION

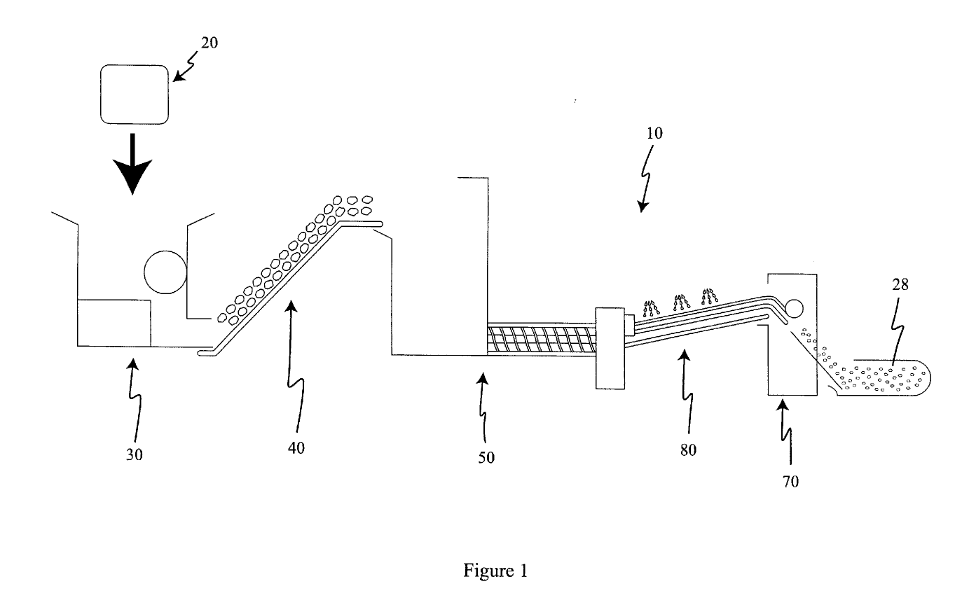

Shown in FIG. 1 is a recycle system 10 for making recycled plastic pellets 28 from raw material 20 according to an embodiment of the present invention. The recycle system 10 has a shredder 30, a conveyor 40, an extruder 50, a cooler 80, and a cutter or pelletizer 70.

The raw material 20 includes but is not limited to scrap diaper waste or feminine product scrap. The raw material 20 may contain contaminants. The raw material 20 is first loaded into the shredder 30, where the raw material 20 is cut into small pieces. The shredded raw material 22 is then fed to the extruder 50 via the conveyor 40. In the extruder 50, the shredded raw material 22 is melt and formed into strands 26, and then sent to the cooler 80. In the cooler 80, the strands 26 are cooled and then sent to the cutter 70 where the strands 26 are cut into smaller pieces (pellets 28).

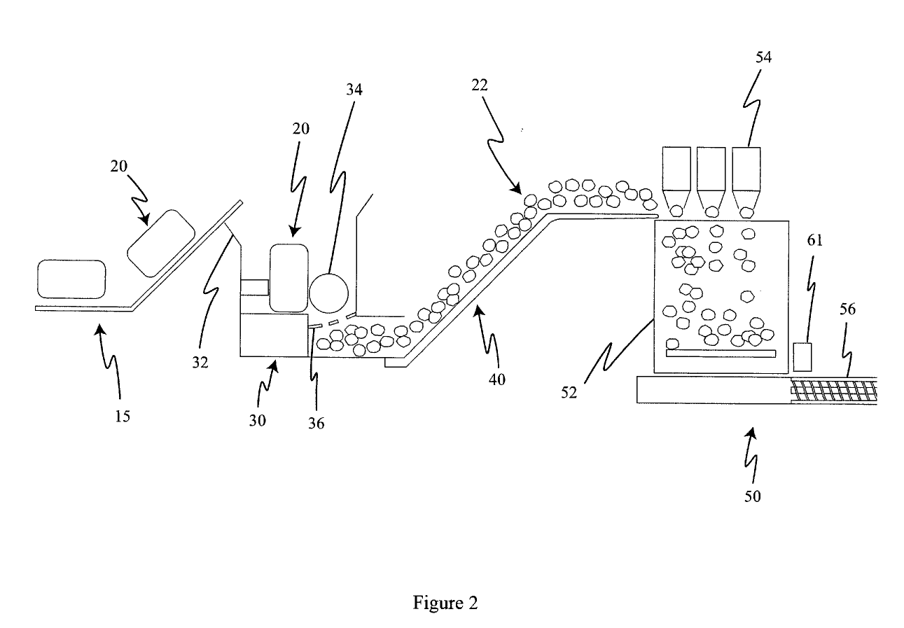

As shown in FIG. 2, the raw material 20 may be fed into the shredder 30 via a feeding conveyor 15. The shredder 30 can be any type of conventional shredder. Preferably, the shredder 30 is designed with three main parts or functions: a hopper/ram part 32, a rotor/cutter part 34 and a screen part 36. The hopper/ram part 32 is designed to receive and hold the raw material 20 and also force the raw material 20 against the rotor/cutter part 34. Once the raw material 20 is forced against the rotor/cutter part 34 blades tear and cut the raw material 20 into smaller sizes that can melt more effectively in the extruder 50. The screen part 36 is used to insure the pieces of the shredded raw material 22 are not too large to go into the extruder 50. The screen part 36 is designed such that if the pieces are too large the rotor/cutter part 34 will cut over and over again until they are the appropriate size (approx 6-8″ diameter) and then push it through the screen part 36 again.

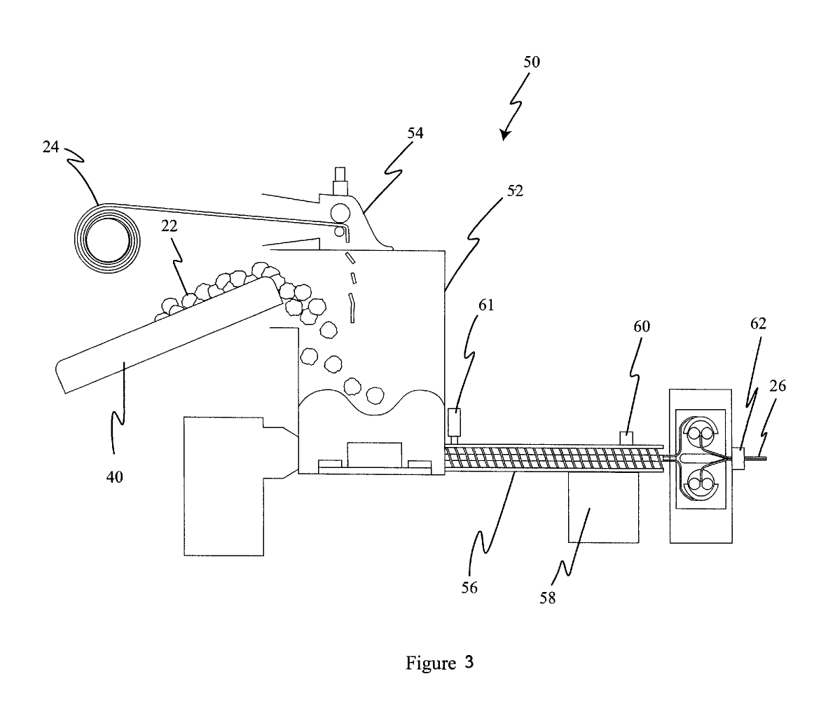

As shown in FIGS. 2 and 3, the shredded raw material 22 is moved into a large densifier 52 of the extruder 50 via the conveyor 40. In the densifier 52, the shredded raw material 22 is cut into smaller pieces and thus densified. The extruder 50 can have one or more additive feeders 54 to add modifier or additive 24 into the densifier 52 to change the impact or other characteristics of the final material. Other types of scrap material may also be added. Such modifier or additive 24 may include PP material to increase strength. Other examples of such modifier or additive 24 may include Matalicine, TPE, TPO, High Izod PP, Calcium, PE, Peroxide. All of these materials will enhance the raw material, either giving it more strength, improving MFI or modifying other characteristics thereof, which will improve overall performance of the initial feed stock.

The material 22 is then sent to an extrusion screw 56. While the material 22 passes through the extrusion screw 56, the material 22 is melt as heat is added to the extrusion screw 56 via a heater 58. In the densifier 52, due to the cutting, some shear stress may heat up the material 22 to cause some melting but the melting primarily happens in the extrusion screw 56 where heat is added. As seen in FIG. 3, passing through the extrusion screw 56, the material 22 also passes through a vacuum area 60 where impurities (or gases) are taken out of the material 22. If necessary, color can be added into the material 22 via a color feeder 61 to make the material 22 uniform in color. Exiting the extruder screw 56, the material 22 also passes through a die head 62 where the material 22 forms plastic strands 26. The die head 62 may be like die heads of spaghetti machines.

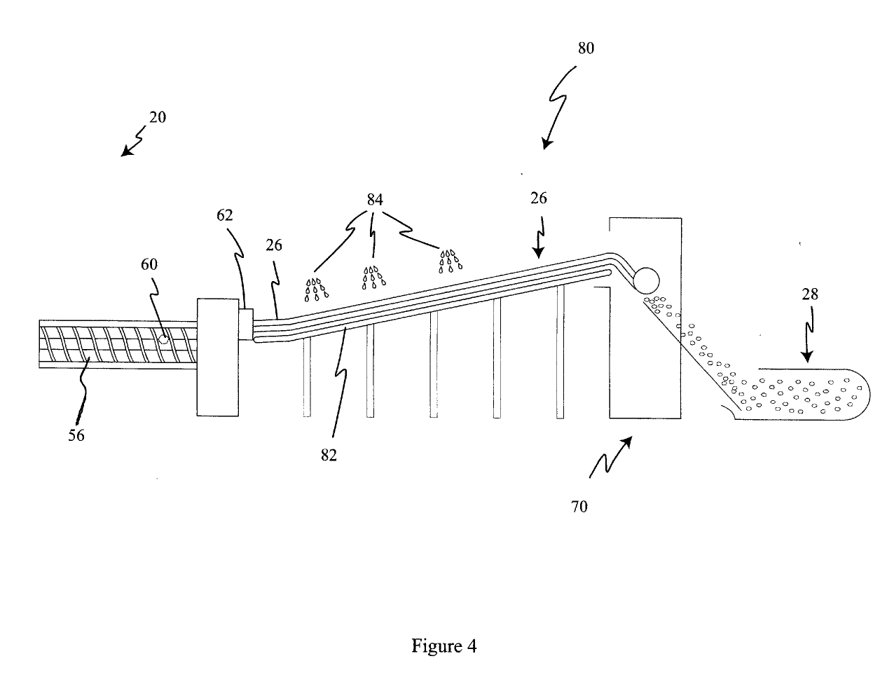

As seen in FIG. 4, the strands 26 are then sent to a cooler 80. The cooler 80 is comprised of a cooling conveyor 82, and further has one or more mist sprayers 84. The cooling conveyor 82 moves the strands 26 to the cutter or pelletizer 70. On the way, the strands 26 are sprayed with mist of water by the mist sprayers 84 to cure the outside of the strands 26. However, preferably, the temperature of the strands 26 must be kept over 212° F. (100° C.), i.e., the boiling point of water, so that no or little water enters the strands 26 and the strands 26 are allowed to stay dry. This is important to process the strands 26 without causing them to carry excess moisture after extruded.

Traditional extruders using an underwater cutter at the end of the line cause the material to carry excess moisture since this material usually have cellulose and SAP (super absorbent polymer—soaks up liquids at a rate of 300 times its weight). This conventional type of underwater cutting employs an extruder die head similar to that of the extruder 70 of the present invention, but instead of the die head being in a straight line it is circular in shape and is in a water filled area as the material comes out of the die head. This water instantly cures the material and then there is a cutter that spins to cut the pellets. In this conventional type of underwater cutter, once the pellets are cut they flow to a drying/shaker table and then into a small drying unit. An Erema extruder line, which is commercially available, was tested and the material soaked up water and took several days to dry in a traditional material drier. Once dried the material could be molded without any special equipment, but the drying is too expensive. In contrast, since most plastic does not soak up water in the extruder 50 or the cutter 70 of the present invention, the present invention provides the most efficient cutting process.

Another conventional cutting for an extruder process is to employ hot plate cutters, which have two hot plates. As the material comes through the plates spin to cure and cut the pellets. The pellets cut by the hot plate cutters are not as clean cut as the pellets obtained by the conventional underwater cutter or the pellets 28 obtained by using the cutter 70 of the present invention. In addition, the output of the hot plate cutters is less than 700 lbs per hour, which is a large capacity constraint. This is too slow, which would make the final pellets too expensive. In contrast, the cutter 70 of the present invention can run in excess of 5000 lbs per hour, depending on the sizes of the extruder 50 and the cutter 70.

The cooled strands 26 are then sent to the cutter or pelletizer 70 where the strands 26 are cut into smaller pieces or pellets 28. The pellets 28 may be vacuum-loaded into super sacks, gaylords or sent directly to a surge mixing bin or silo. From there it is shipped to the customer by either trucks or railcars. A Scheer Bay strand cutter, which is commercially available, can be used as the cutter 70 of the present invention because it will meet the requirement of keeping the strands 26 dry with a required or acceptable output rate.

The recycle system 10 according the present invention need not remove contaminants out of the raw material 20 after shredded but may use the post industrial waste in its entirety so that no special equipment would be needed for cleaning the shredded raw material 22 or molding the final product. This is also advantageous in that no part of the raw material would go to the land fill, which means that not only is environmentally friendly but it also is a material that can be used over and over again. Still, no out-gassing of pellet during molding operation will happen since most impurities would be taken out in gaseous state during the extrusion process via the vacuum area 60.

In addition, the recycle system 10 according to the present invention can have the ability to add impact modification to the product so it could be used in unlimited consumer, industrial and commercial plastic applications.

The final pellets 28 produced according to the present invention require no extra handling after they are produced. Conventional pellets such as California pellets needed to be handled several more times before part is produced. In addition, the final pellets 28 produced according to the present invention may be vacuum fed directly from the cutter or pelletizer 70 to silo without any additional handling.

The recycle system 10 according to the present invention can produce pellets 28 with much higher density than conventional systems did so that resin pellet can be used in a normal molding press without augers, crammers or extra large machines. The pellets 28 produced according to the present invention become very similar to virgin pellets.

As various modifications could be made to the exemplary embodiments, as described above with reference to the corresponding illustrations, without departing from the scope of the invention, it is intended that all matter contained in the foregoing description and shown in the accompanying drawings shall be interpreted as illustrative rather than limiting. Thus, the breadth and scope of the present invention should not be limited by any of the above-described exemplary embodiments, but should be defined only in accordance with the following claims appended hereto and their equivalents.

What is claimed is:

1. A recycle system for making recycled plastic pellets comprising:
a shredder for shredding raw material;
an extruder for extruding strands from the shredded raw material;
a cooler for cooling the strands; and
a cutter for cutting the strands into pellets;
wherein said cooler cools the strands such that the temperature of the strands is maintained above a predetermined temperature.

2. The recycle system of claim 1, wherein said predetermined temperature is a boiling point of water.

3. The recycle system of claim 2, wherein said cooler comprises a cooling conveyor.

4. The recycle system of claim 3, wherein said cooler further comprises a mist-sprayer.

5. The recycle system of claim 1, wherein said extruder further has a densifier for receiving and densifying the shredded raw material.

6. The recycle system of claim 5, wherein said extruder further has an additive feeder for adding additive into said densifier.

7. The recycle system of claim 5, wherein said extruder further has an extrusion screw for receiving the densified raw material, a heater for adding heat to said extrusion screw to melt the densified raw material passing through said extrusion screw, and a head die for creating strands from the melted raw material.

8. The recycle system of claim 7, wherein the extruder further has a color feeder for adding color to the raw material passing through said extrusion screw.

9. The recycle system of claim 7, wherein said extruder further has a vacuum area for removing impurities out the raw material passing through said extrusion screw.

10. The recycle system of claim 1, further comprising a conveyor for moving the shredded raw material from said shredder to said extruder.

11. A process for making recycled plastic pellets, comprising:
shredding raw material in a shredding station;
extruding strands from the shredded raw material in an extruding station;
cooling the strands such that the temperature of the strands are maintained above a predetermined temperature in a cooling station; and
cutting the strands into pellets in a cutting station.

12. The process of claim 11, wherein said predetermined temperature is a boiling point of water.

13. The process of claim 11, wherein the cooling step comprises spraying the strands with mist.

14. The process of claim 11, wherein the extruding step further comprises densifying the shredded raw material in a densifier.

15. The process of claim 11, wherein the extruding step further comprises adding additive to the shredded raw material.

16. The process of claim 14, wherein the extruding step further comprises passing the densified raw material through an extrusion screw, adding heat to said extruding screw to melt the densified raw material passing through said extrusion screw, and passing the melt raw material through a head die to form strands.

17. The process of claim 16, wherein the extruding step further comprises adding color to the raw material passing through said extrusion screw.

18. The process of claim 16, wherein the extruding step further comprises vacuuming the raw material passing through said extrusion screw to remove impurities therefrom.

19. The process of claim 11, further comprising moving the strands from said extruding station to said cutting station, wherein the strands are further cooled during the moving.

20. The process of claim 11, further comprising moving the shredded raw material from said shredding station to said extruding station.
